(19) United States
(12) Patent Application Publication
(10) Pub. No.: US 2009/0150490 A1
(43) Pub. Date: Jun. 11, 2009

(54) METHODS INVOLVING ARCHIVING CHAT SESSIONS

(75) Inventors: Kimilee S. Gile, Leominister, MA (US); Elaine I. Kuo, North Chelmsford, MA (US); Fang Lu, Billerica, MA (US); Corey S. McCaffrey, Boston, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/954,094

(22) Filed: Dec. 11, 2007

(51) Int. Cl. G06F 15/16

(52) U.S. Cl. 709/204

(57) ABSTRACT

An exemplary method for archiving chat sessions comprising, receiving text from chat sessions designated for archiving, requesting an identifier of a chat session archive file, receiving the identifier, determining whether a chat session archive file having the identifier exists in a memory, opening the chat session archive file having the identifier, responsive to determining that a chat session archive file having the identifier exists in the memory, adding the text from the designated chat sessions to the chat session archive file having the identifier, saving the chat session archive file having the identifier in a memory, creating a new chat session archive file having the identifier responsive to determining that a chat session archive file having the identifier does not exist., inserting the text from the designated chat sessions into the new chat session archive file, and saving the new chat session archive file in the memory.

### BACKGROUND OF THE INVENTION

1. Field of the Invention

This invention relates generally to methods for archiving chat sessions, and specifically to organizing and compiling multiple chat sessions.

2. Description of Background

Instant message chat sessions may be conducted with multiple participants over a network such as, for example, the Internet. Each participant may participate in a particular chat session, or a user may conduct multiple chat sessions with many users at the same time. Instant messaging software allows users to conduct multiple chat sessions with one or more users. One way of organizing multiple chats is to use tabs that have titles identifying the chat by the participants or a title. It is often desirable to save and archive the text from chat sessions.

### SUMMARY OF THE INVENTION

The shortcomings of the prior art are overcome and additional advantages are achieved through an exemplary method for archiving chat sessions, the method comprising, receiving text from chat sessions designated for archiving, requesting an identifier of a chat session archive file, receiving the identifier of the chat session archive file, determining whether a chat session archive file having the received identifier exists in a memory, opening the chat session archive file having the received identifier, responsive to determining that a chat session archive file having the received identifier exists in the memory, adding the text from the chat sessions designated for archiving to the chat session archive file having the received identifier, saving the chat session archive file having the received identifier in a memory, creating a new chat session archive file having the received identifier responsive to determining that a chat session archive file having the received identifier does not exist, inserting the text from the chat sessions designated for archiving into the new chat session archive file, and saving the new chat session archive file in a memory.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a block diagram of an exemplary method for archiving chat sessions.

FIG. 2 illustrates an exemplary system for archiving chat sessions.

FIGS. 3-4 illustrate an exemplary embodiment of chat session window illustrating the method of FIG. 1.

FIGS. 5-7 illustrate exemplary embodiments of chat session archive files further illustrating the method of FIG. 1.

The detailed description explains the preferred embodiments of the invention, together with advantages and features, by way of example with reference to the drawings.

### DETAILED DESCRIPTION OF THE INVENTION

Methods involving archiving chat sessions are provided. Several exemplary embodiments are described.

Chat sessions are often conducted over the Internet between multiple users. Many chat session applications allow users to archive the text from chat sessions into a file. Often, however, users may have text from previous chat sessions that the user may desire to save in an existing file already containing text from previous chat sessions. Thus, it is desirable to for a method that allows a user to add the text from a chat session to a file that already contains text from previous chat sessions.

Additionally, when a user is conducting a chat session with multiple users it may be desirable to designate the text from chats with multiple users to be archived in a single file. The text from multiple users may then be saved in a new file, or added to a previously saved file.

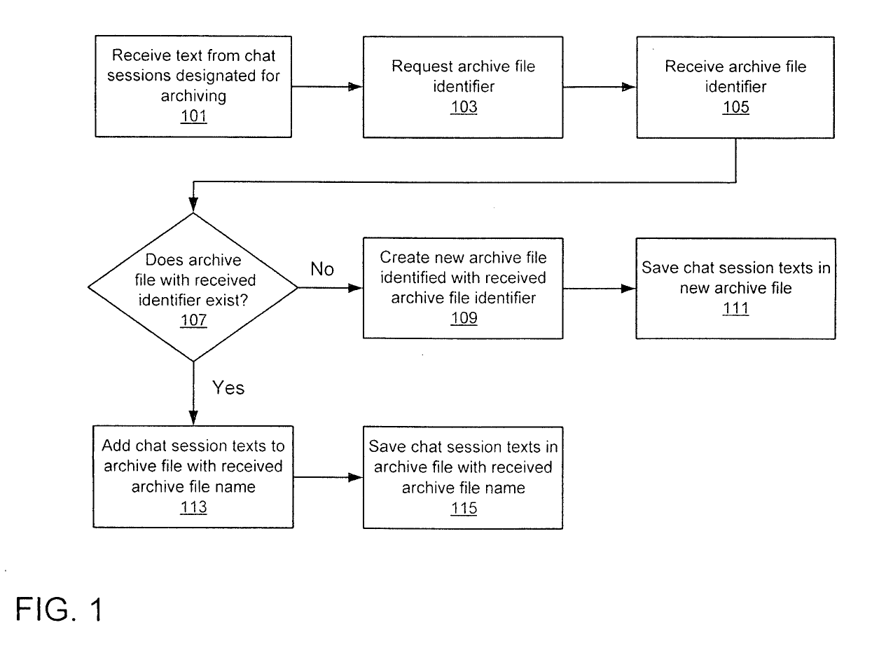

FIG. 1 illustrates a block diagram of an exemplary method for archiving chat sessions. In block 101, the text from chat sessions designated for archiving are received. The user may designate multiple chat sessions or a single chat session. An archive file identifier is requested in block 103. An archive file identifier may, for example, be a file name such as a date of the chat sessions, a subject of the chat session, or participants in the chat session. The archive file identifier is received in block 105. In block 107, it is determined whether an archive file with the received archive file identifier exists. If no archive file having the received archive file identifier exists, a new archive file is created with the received archive file identifier in block 109. In block 111, the received chat session text is saved in the new archive file.

If it is determined in block 107 that an archive file with the received archive file identifier does exist, the received chat session texts are added to the existing archive file with the received archive file identifier. The text may be added at the bottom of the archive file following the text from previous chat sessions that have been previously saved in the existing archive file. In block 1 15, the chat session text in the existing archive file is saved in the existing archive file.

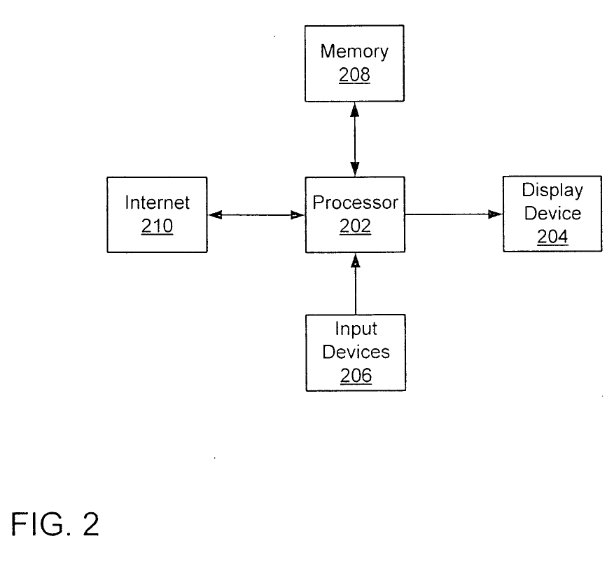

FIG. 2 illustrates an exemplary embodiment of a system for archiving chat sessions. The exemplary system includes a processor 202 communicatively linked to a display device 204, a memory 208, and input devices 206, and the Internet 210.

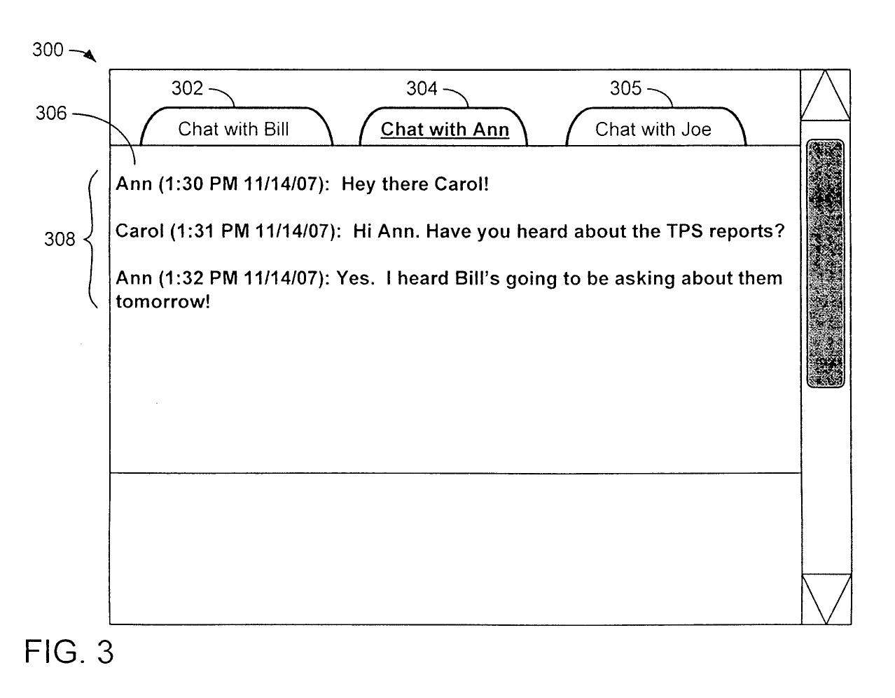

FIGS. 3-7 illustrate exemplary embodiments of a user interface with outputs from the methods described above. Referring to FIG. 3, an exemplary chat session window 300 is shown. In the chat session window 300 a user “Carol” is conducting a chat with “Bill.” “Ann,” and “Joe.” Tabs 302, 304, and 305 show the active chats. In the illustrated embodiment, a user may select one of the labs 302, 304, and 305. Once the tab 304, for example, is selected, a chat text with Ann 308 is displayed in a chat window 306.

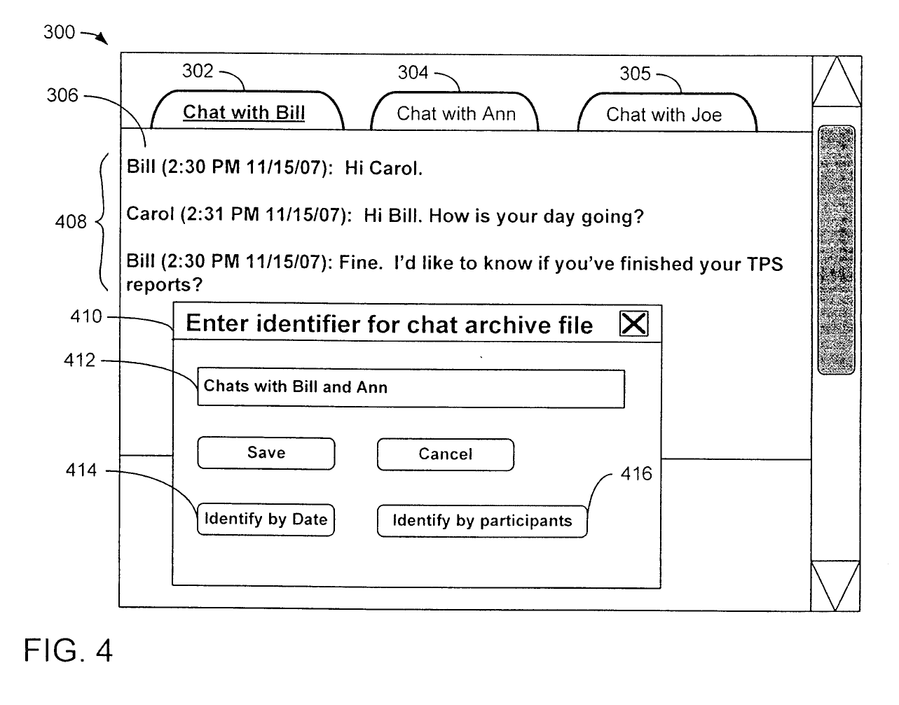

In FIG. 4, the tab 302 has been selected and a chat text with Bill 408 is displayed in the chat window 306. A user may designate chat text for saving in an archive file by, for example, selecting one or more of the tabs 302, 304, and 305 and entering a command (o save the text. Once the command to save the text has been received, a chat archive file identifier window 410 may be displayed that has a chat file identifier entry field 412. A user may enter an identifier of a chat session archive file in the chat file identifier entry field 412. The chat archive file identifier window 410 may also include an “identify by date” option 414 that automatically enters the dates of the chats as the identifier of a chat session archive file in the chat file identifier entry field 412. The identifier of a chat session archive file may also be the participants of the chats and may be automatically entered the chat file identifier entry field 412 when the user selects an “identify by participants” option 416.

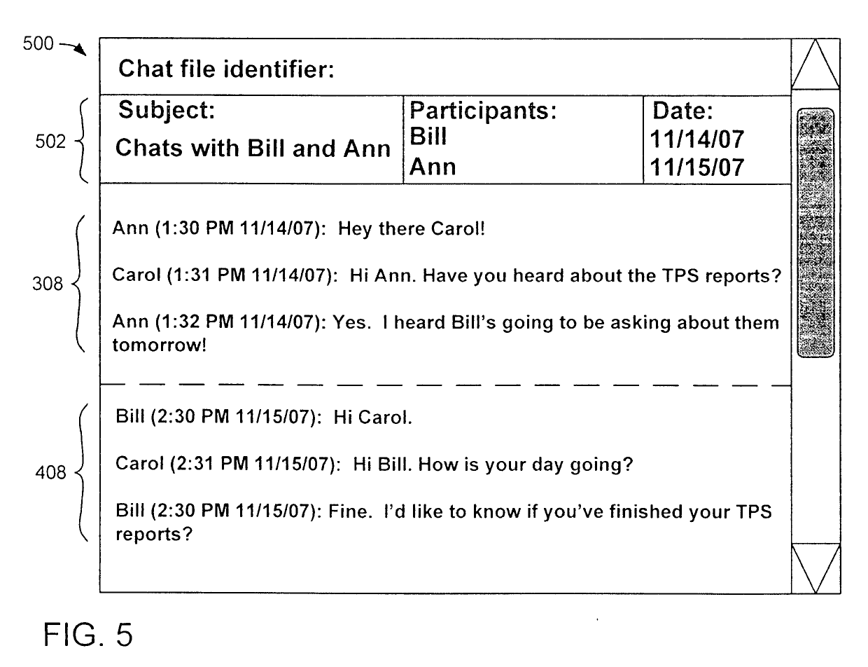

FIG. 5 illustrates an exemplary embodiment of a chat session archive file 500. The chat session archive file 500 shows a possible chat session archive file after it is determined that no archive file with a received archive file identifier exists (from FIG. 1, block 107). The chat session archive file 500 includes three types of chat file identifiers 502, a subject identifier “Chats with Bill and Ann,” a participant identifier “Bill Ann,” and a date identifier “11/14/07 11/15/07.” In the chat session archive file 500 the chat text with Ann 308 (from FIG. 3) and the chat text with Bill 408 (from FIG. 4) have been added to the file.

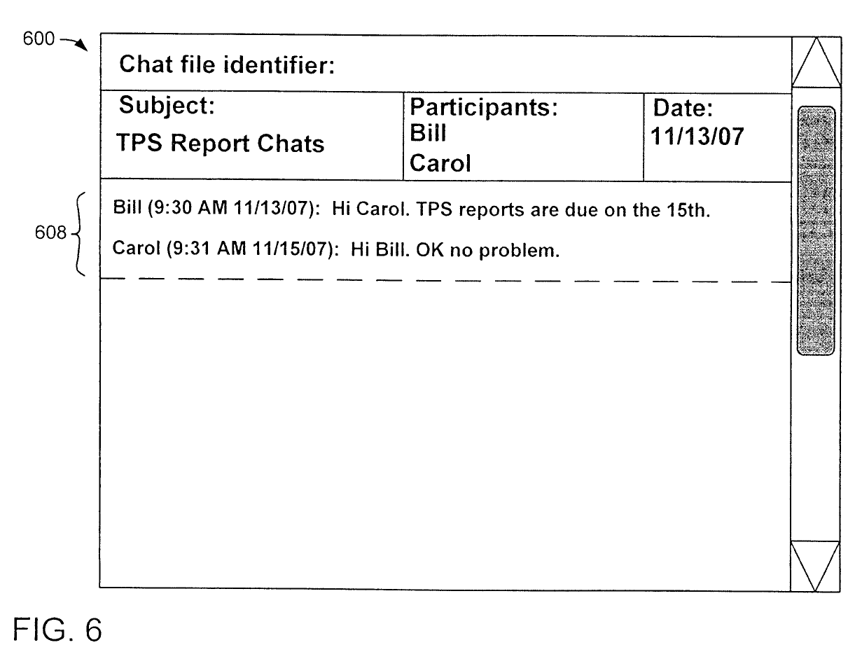

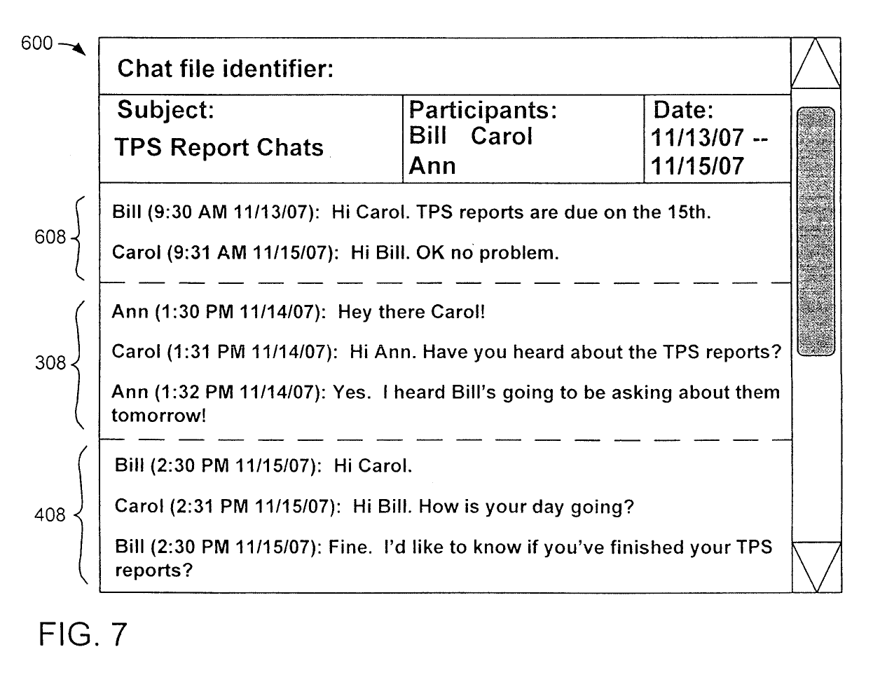

FIG. 6 illustrates an exemplary embodiment of a chat session archive file 600. The chat session archive file 600 shows a possible chat session archive file after it is determined that an archive file with a received archive file identifier does exist (from FIG. 1, block 107). The chat session archive file 600 has a chat text 60S that has previously been saved in the chat session archive file 600. Referring now to FIG. 7, the chat session archive file 600 now also includes the chat text with Ann 308 (from FIG. 3) and the chat text with Bill 408 (from FIG. 4) that have been added to the file below the chat text 608.

While the preferred embodiment to the invention has been described, it will be understood that those skilled in the art, both now and in (he future, may make various improvements and enhancements which fall within the scope of the claims which follow. These claims should be construed to maintain the proper protection for the invention first described.

What is claimed is:

1. A method for archiving chat sessions, the method comprising:
receiving text from chat sessions designated for archiving;
requesting an identifier of a chat session archive file;
receiving the identifier of the chat session archive file;
determining whether a chat session archive file having the received identifier exists in a memory;
opening the chat session archive file having the received identifier, responsive to determining that a chat session archive file having the received identifier exists in the memory;
adding the text from the chat sessions designated for archiving to the chat session archive file having the received identifier;
saving the chat session archive file having the received identifier in the memory;
creating a new chat session archive file having the received identifier responsive to determining that a chat session archive file having the received identifier does not exist in the memory;
inserting the text from the chat sessions designated for archiving into the new chat session archive file; and
saving the new chat session archive file in the memory.

2. The method of claim 1, wherein the identifier of a chat session archive file includes:
a date;
a session title;
a subject; and
names of participants in the chat sessions.
